(19) United States
(12) Patent Application Publication
(10) Pub. No.: US 2008/0259198 A1
(43) Pub. Date: Oct. 23, 2008

(54) PORTABLE ELECTRONIC DEVICE AND METHOD FOR ADJUSTING BACKLIGHT THEREOF

(75) Inventors: YU-HSIN CHEN, Jen Te (TW); JUNG-CHIEH WONG, Jen Te (TW); FA-HSIANG CHANG, Jen Te (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tainan County (TW)

(21) Appl. No.: 11/933,916

(22) Filed: Nov. 1, 2007

(30) Foreign Application Priority Data
Apr. 20, 2007 (CN) 200710074124.4

(51) Int. Cl. H04N 5/238; G09G 1/14

(52) U.S. Cl. 348/333.01; 348/364; 348/222.1; 345/20

(57) ABSTRACT

A method for adjusting backlight includes a series of operations. Providing a portable electronic device (10), the portable electronic device including an image sensor (12), a signal processor (14), a backlight adjuster (16) and a backlight module (18), which are all electronically connected together. The image sensor senses an outside light and transforms the sensed outside light to an optical image signal, and sends the optical image signal to the signal processor. The signal processor determines the backlight intensity that the backlight module should provide according to the received optical image signal, and sends a control signal to the backlight adjuster. The backlight adjuster dynamically adjusts the backlight provided by the backlight module based on the control signal sent from the signal processor. A portable electronic device is also disclosed.

### BACKGROUND OF THE INVENTION

1. Field of the Invention

The present invention relates to portable electronic devices, and more specifically to a portable electronic device that can dynamically adjust backlight thereof with an image sensor and a method for adjusting backlight.

2. Description of Related Art

With the development of the technology of information processing, portable electronic devices such as digital cameras, video cameras, mobile phones, notebook computers, and personal digital assistants (PDAs) are now in widespread use. Usually, such a portable electronic device may be used in variable outside brightness. If the backlight intensity is invariable and not dynamically adjustable to the outside light intensity, the users may feel uncomfortable. Furthermore, the unwanted light also causes a waste of energy.

Therefore, a traditional luminosity sensor is provided in a portable electronic device. The backlight of the portable electronic device is adjusted according to the brightness sensed by the luminosity sensor, so that the power consume could be decreased.

However, the portable electronic devices nowadays tends to be light, thin, short, and small. In the market, portable electronic devices are becoming increasingly multifunctional, and some functional modules are introduced as special features for portable electronic devices. If the portable electronic devices further use the luminosity sensor to occupy a space in the portable electronic device, the bulk of the portable electronic device may be relatively large, and the cost of the electronic device is likely to increase.

Therefore, a portable electronic device that can dynamically adjust a backlight thereof with a small bulk and a method for dynamically adjusting backlight are desired to overcome the above-described shortcomings.

### SUMMARY

In one aspect thereof, a method for adjusting backlight of a portable electronic device includes a series of operations. Providing the portable electronic device that includes an image sensor electronically connected to a signal processor which is electronically connected to a backlight adjuster which is electronically connected to a backlight module. The image sensor senses an outside light and transforming the sensed outside light into an optical image signal, and sending the optical image signal to the signal processor. The signal processor determines the backlight intensity that the backlight module should provide according to the received optical image signal, and sending a control signal to the backlight adjuster. The backlight adjuster dynamically adjusts the backlight provided by the backlight module based on the control signal received from the signal processor.

In another aspect thereof, a portable electronic device includes an image sensor, a signal processor, a backlight adjuster, and a backlight module. The image sensor is configured for sensing and transforming an outside light into an optical image signal, and sending the optical image signal. The signal processor is electronically connected to the image sensor and configured for receiving the optical image signal sent from the image sensor, determining the needed backlight intensity according to the received optical image signal, and sending a control signal. The backlight adjuster is electronically connected to the signal processor and configured for receiving the control signal from the signal processor, and dynamically adjusts the backlight based on the received control signal. The backlight module is electronically connected to the backlight adjuster and configured for supplying backlight for the portable electronic device, wherein the backlight is dynamically adjusted by the backlight adjuster.

Other advantages and novel features of the present invention will become more apparent from the following detailed description of preferred embodiment when taken in conjunction with the accompanying drawings.

### BRIEF DESCRIPTION OF THE DRAWINGS

Many aspects of the present portable electronic device which can dynamically adjusting backlight thereof and method for adjusting backlight can be better understood with reference to the following drawings. The components in the drawings are not necessarily drawn to scale, the emphasis instead being placed upon clearly illustrating the principles of the present device and method. Moreover, in the drawings, like reference numerals designate corresponding parts throughout the several views.

FIG. 1 is a functional module diagram of a portable electronic device which can dynamically adjust backlight, according to a present embodiment; and

FIG. 2 is a flow chart of a method for adjusting backlight, according to a present embodiment.

### DETAILED DESCRIPTION OF THE EMBODIMENT

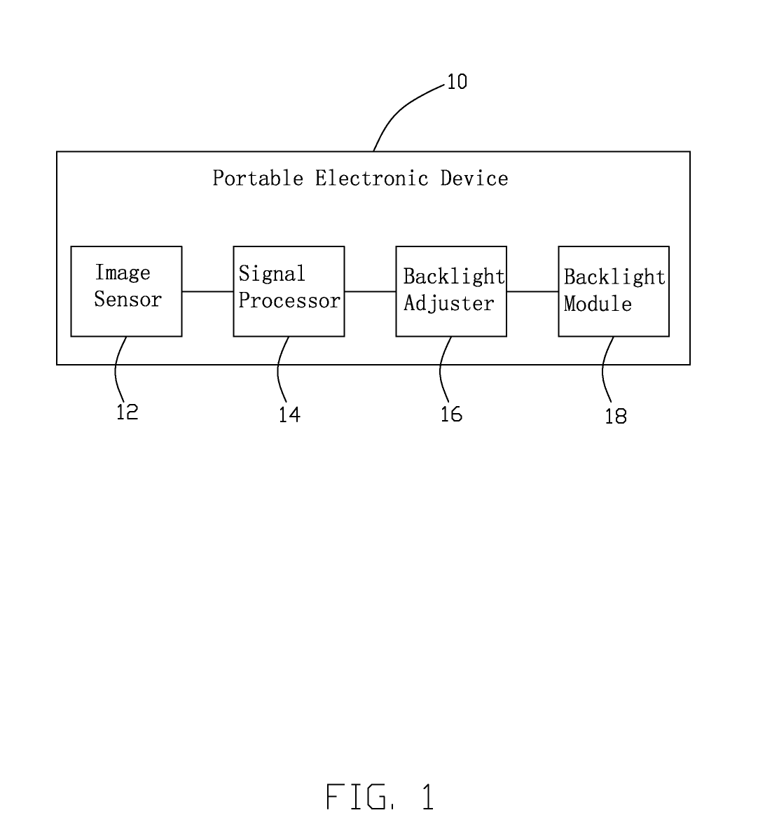

Referring to FIG. 1, in a present embodiment, a portable electronic device 10 that can dynamically adjust backlight includes an image sensor 12, a signal processor 14 electronically connected to the image sensor 12, a backlight adjuster 16 electronically connected to the signal processor 14, and a backlight module 18 electronically connected to the backlight adjuster 16. The image sensor 12 is provided for sensing a light from outside, i.e., the environmental light, and transforming the sensed light into an optical image signal to be sent to the signal processor 14. The signal processor 14 is configured for processing the optical image signal received from the image sensor 12 and generating a control signal in response. The backlight module 18 is provided for supplying backlight for the portable electronic device 10. The backlight adjuster 16 is provided for controlling the start and stop function of the backlight module 18 along with controlling the backlight intensity from the backlight module 18 in accordance with the control signal generated by the signal processor 14.

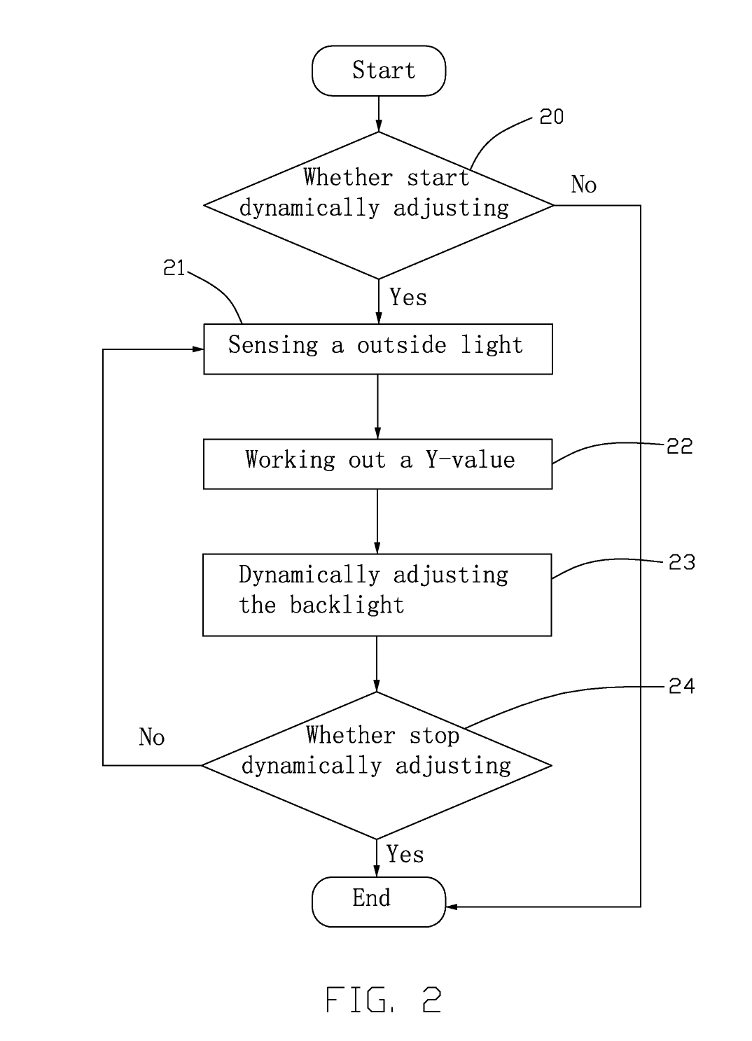

Referring to FIG. 2, a process of dynamically adjusting backlight in accordance with the present embodiment is provided. In operation 20, during the working state of the portable electronic device 10, a user selects whether or not to dynamically adjust the backlight according to actual need. If positive, operation 21 is performed. If negative, the process of dynamically adjusting backlight will be stopped. The image sensor 12 senses an outside (or environmental) light and transforms it into an optical image signal. The optical image signal is sent to the signal processor 14 by the image sensor 12. In operation 22, the signal processor 14 transforms the received optical image signal from an analog signal into a digital signal, and figures out a Y-value of the optical image signal in a YUV color space, wherein Y is luma or luminance, U and V are chrominance or chroma. The outside luminance can be resulted from the Y-value of the optical image signal. The signal processor 14 determines the backlight intensity that the backlight module 18 should provide according to the Y-value, and sends a control signal to the backlight adjuster 16. In operation 23, the backlight adjuster 16 adjusts the backlight provided by the backlight module 18 based on the control signal received from the signal processor 14. In operation 24, the user selects whether or not to stop dynamically adjusting backlight according to an actual need. If the backlight is stopped, the process of dynamically adjusting backlight ends. If the backlight is not stopped, the process return to operation 21.

Take a mobile phone using a TFT (thin film transistor) screen as an example. If the light intensity of the screen is invariable, the screen gets darker as the outside light intensity is high, and contrarily, the screen gets brighter and may become too glaring when the outside light intensity is low. Therefore, dynamically adjusting the backlight is needed. In use, the image sensor 12 installed in the inner camera module of the mobile phone senses the outside light and transforms the sensed outside light into an optical image signal. The optical image signal is sent to the signal processor 14. The signal processor 14 figures out the outside light intensity based on the optical image signal received from the image sensor 12. The signal processor 14 determines the amount of required backlight intensity according to the figured outside light intensity, and sends a corresponding control signal to the backlight adjuster 16. The backlight adjuster 16 dynamically adjusts the backlight intensity provided by the backlight module 18 following the received control signal. Therefore, the backlight intensity of the mobile phone increases in accordance with the increasement of the outside light intensity. When the outside light intensity is high, the screen becomes relatively clear to the user. When the outside is dark, the light intensity of the mobile phone screen decreases and establish a power-saving mode to avoid the excessive glaring.

Of course, if the keypad of the mobile phone has a backlight module 18, the brightness of the keypad may also be dynamically adjusted. The portable electronic device 10 can also be other devices such as a PDA (personal digital assistant), a digital camera, a notebook computer, etc.

It should be understood that, it is inconvenient for the user to frequently change the backlight intensity. To avoid that, the values of different outside light intensity should be grouped into several parts and stored in the signal processor 14. Each part of the outside light intensity values corresponds to the required backlight intensity. If the signal processor 14 has no Y-value figuring function, a hue transformation can be used instead, that is, the Y-value is figured out by transforming the light information from RGB (Red-Green-Blue) color space into the YUV color space, so the signal processor 14 can work out the Y-value without calculating directly. It should also be understood that, the outside light intensity could be continually detected during the working state of the present portable electronic device, and the backlight intensity can be dynamically adjusted.

The portable electronic device 10 can dynamically adjusting backlight and method for adjusting backlight require no traditional luminosity sensor, instead it use an image sensor 12 of the portable electronic device 10 to dynamically adjust the backlight, to bring more convenience, to save the product cost, and to reduce the bulk of the portable electronic device 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for adjusting backlight of a portable electronic device, comprising the following operations:
providing the portable electronic device that includes an image sensor electronically connected to a signal processor which is electronically connected to a backlight adjuster which is electronically connected to a backlight module;
the image sensor sensing an outside light and transforming the sensed outside light into an optical image signal, and sending the optical image signal to the signal processor;
the signal processor determining the backlight intensity that the backlight module should provide according to the received optical image signal, and sending a control signal to the backlight adjuster; and
the backlight adjuster dynamically adjusting the backlight provided by the backlight module based on the control signal received from the signal processor.

2. The method for adjusting backlight as described in claim 1, wherein the signal processor figures out a Y-value of the optical image signal in a YUV color space according to the received optical image signal, determines a backlight intensity the backlight module needs to provide according to the Y-value, and sends a control signal to the backlight adjuster.

3. The method for adjusting backlight as described in claim 2, wherein the Y-values of the optical image signal with different outside light intensities are grouped into several parts which are stored in the signal processor, each part of the Y-values corresponds to a certain needed backlight intensity.

4. The method for adjusting backlight as described in claim 1, wherein a hue transformation is applied on the optical image signal received by the signal processor, the optical image signal being transformed from an RGB color space into a YUV color space, and the signal processor working out the Y-value of the optical image signal in a YUV color space.

5. The method for adjusting backlight as described in claim 4, wherein the Y-values of the optical image signal with different outside light intensities are grouped into several parts which are stored in the signal processor, each part of the Y-values corresponding to a certain needed backlight intensity.

6. A portable electronic device, comprising:
an image sensor configured for sensing and transforming an outside light into an optical image signal, and sending the optical image signal;
a signal processor electronically connected to the image sensor and configured for receiving the optical image signal sent from the image sensor, determining the needed backlight intensity according to the received optical image signal, and sending a control signal;
a backlight adjuster electronically connected to the signal processor and configured for receiving the control signal from the signal processor, and dynamically adjusting the backlight based on the received control signal;
a backlight module electronically connected to the backlight adjuster and configured for supplying backlight for the portable electronic device, wherein the backlight is dynamically adjusted by the backlight adjuster.

7. The portable electronic device as described in claim 6, wherein the signal processor figures out a Y-value of the optical image signal in a YUV color space according to the received optical image signal, determines a backlight intensity the backlight module needs to provide according to the Y-value, and sends a control signal to the backlight adjuster.

8. The portable electronic device as described in claim 7, wherein Y-values of the optical image signal with different outside light intensities are grouped into several parts which are stored in the signal processor, each part of the Y-values corresponding to a predetermined backlight intensity.

9. The portable electronic device as described in claim 6, wherein a hue transformation is applied on the optical image signal received by the signal processor, the optical image signal is transformed from light information of the sensed outside light from a RGB color space into a YUV color space, and the signal processor works out the Y-value of the optical image signal in a YUV color space.

10. The portable electronic device as described in claim 9, wherein the Y-values of the optical image signal with different outside light intensity are grouped into several parts by the signal processor and the grouped several parts are stored in the signal processor, each part of the Y-values corresponding to a predetermined backlight intensity.
